(19) United States
(12) Patent Application Publication
(10) Pub. No.: US 2023/0415846 A1
(43) Pub. Date: Dec. 28, 2023

(54) PEDAL-DRIVE VEHICLE AND FRAME FOR A PEDAL-DRIVE VEHICLE

(71) Applicant: FreeFlow Technologies Limited, Glasgow (GB)

(72) Inventors: Neil Edwards, Glasgow (GB); Neil MacMartin, Glasgow (GB); Philip Wood, Glasgow (GB)

(21) Appl. No.: 18/038,811

(22) PCT Filed: Nov. 26, 2021
(86) PCT No.: PCT/GB2021/053074

§ 371 Date: May 25, 2023

(30) Foreign Application Priority Data
Nov. 26, 2020 (GB) 2018663.1
Aug. 31, 2021 (GB) 2112415.1

(51) Int. Cl. B62M 6/55; B62J 43/13; B62J 43/28; B62K 3/04; B62K 19/34; B62M 6/90; B62K 19/40

(52) U.S. Cl. CPC B62M 6/55; B62J 43/13; B62J 43/28; B62K 3/04; B62K 19/34; B62M 6/90; B62K 19/40

(57) ABSTRACT

A frame for a pedal driven vehicle, the frame having a first portion that defines an open channel. The frame includes fixture points for releasably securing a drive assembly having a crank axle to the frame, such that the drive assembly can be secured in the open channel, via the fixture points, so as to define an operational crank axis of the drive assembly. The frame defines one or more compartments for receiving a battery, so that the battery can be arranged in communication with the drive assembly for the transfer of motive power from the battery to the drive assembly (i.e. for driving the crank axle) whilst the battery is located in the compartment. The drive assembly is moveable in and out of the open channel in a movement which is in a non-axial direction of the channel.

### FIELD

The present invention relates to a pedal-drive vehicle and a frame for a pedal-drive vehicle.

### BACKGROUND

Electric pedal-drive vehicles, e.g. bicycles, include two forms of motive power: an electric motor and a pedal driven crank system. The electric motor can be used to augment or replace motive force provided by a rider via the pedal driven crank system.

The electric motor and any gearing is typically located within a bottom bracket shell of the bicycle frame. The battery that powers the electric motor is traditionally located within one of the hollow tubes of the vehicle (e.g. seat tube, down tube), where it can only be accessed with the removal of the electric motor and gearing from the bottom bracket shell.

Removing the electric motor and gearing from the bottom bracket shell is not a simple process, and can take a significant amount of time.

The present teachings seek to overcome or at least mitigate one or more problems associated with the prior art.

### SUMMARY OF THE INVENTION

In a first aspect of the disclosure, there is provided a pedal-drive vehicle comprising a frame having a first portion or bottom bracket shell, a seat tube, a down tube, wherein the seat tube and the down tube each have an end that terminates at the first portion; wherein the first portion of the frame defines an open channel; wherein a drive assembly having a crank axle is releasably secured in the open channel, such that the drive assembly defines a longitudinal operational axis; wherein a battery is located within a hollow interior of one of the seat tube and the down tube; wherein the battery is provided for transmission of auxiliary power to the drive assembly, via an aperture in the first portion, such that the battery can communicate with the drive assembly through the aperture; and wherein the frame is configured such that the battery is removable along an axis of reciprocation within the seat tube or down tube, via the aperture in the first portion, when the drive assembly is released from the open channel.

Advantageously, the battery can be removed from the frame through the open channel when the drive assembly has been released from the operational position. Such an arrangement is in contrast to conventional systems, where the battery is often difficult to access and requires an access point in a tube of the frame.

The term ‘open channel’ is intended to mean that the channel does not define a full annulus/circumference, contrary to conventional bicycle frames (wherein the seat tube and down tube terminate at a first portion or bottom bracket shell which defines a closed, fully annular profile in cross section).

In exemplary embodiments, the axis of reciprocation of the battery intersects the operational axis of the drive assembly.

In exemplary embodiments, the drive assembly a generally cylindrical drive assembly.

In exemplary embodiments, the battery has an elongate body with a length greater than a maximum width of the open channel as viewed in cross section.

Advantageously, a full-sized battery can easily be removed from the interior of one of the tubes without any risk of damaging the battery or the frame by impact between the battery and frame.

In exemplary embodiments, the axis of reciprocation of the battery intersects the operational axis of the drive assembly.

In exemplary embodiments, the internal shape of the first portion is configured to allow the drive assembly to be received and removed from the open channel in a generally ‘radial’ direction with respect to the normal operational position of the drive assembly (that is to say, not in an ‘axial’ direction with respect to a crank axis of the drive assembly.

In exemplary embodiments, the frame includes mechanical fixture points adjacent the open channel for releasably securing the drive assembly in the open channel.

Advantageously, the use of mechanical fixtures adjacent the open channel provides a simple means for allowing the drive assembly to be releasably secured in the open channel, so that the drive assembly can be easily removed from the open channel (e.g. for maintenance reasons).

In exemplary embodiments, the vehicle is configured so that the drive assembly is moveable out of the channel when coupled to one of said fixture points.

In exemplary embodiments, the drive assembly is moveable out of the channel via a pivoting movement.

In exemplary embodiments, the vehicle is configured so that the drive assembly is able to swing out of the channel from an operational position to a maintenance position, e.g. via a pivoting movement, whilst coupled to one of said fixture points (that is to say, whilst released from coupling to the other of said first and second fixture points).

Advantageously, utilising a pivotal connection is a simple means of moving the drive assembly between its operational position and maintenance position. Such an arrangement further increases the ease of accessing the open channel, and can thus expedite certain maintenance operations.

Advantageously, such an arrangement provides a simple and easy means for the user to move the drive assembly between the operational and maintenance position for access to the assembly or the interior of the channel without having to completely remove the assembly from the frame, and without having to handle the weight of the assembly.

In exemplary embodiments, the vehicle includes a first mechanical arrangement for coupling the drive assembly to the frame, and wherein the first mechanical arrangement is configured to allow the drive assembly to be moved in and out of the open channel, between an operational position and a maintenance position, whilst the drive assembly is coupled to the frame via the first mechanical arrangement.

The first mechanical arrangement advantageously allows the drive assembly to be moved in and out of the open channel whilst coupled to the frame.

In addition, the use of a first mechanical arrangement as set forth allows for the drive assembly to remain coupled with the frame when the drive assembly is in the maintenance position i.e. removed from the channel. Such an arrangement improves the ease at which maintenance can be done to the vehicle, as the drive assembly can be easily removed from the channel without having to completely disconnect the drive assembly from the frame.

In exemplary embodiments, the vehicle includes a second mechanical arrangement for use in releasably securing the drive assembly in the open channel in an operational position, wherein the first mechanical arrangement is provided on one side of the open channel and the second mechanical arrangement is provided on an opposing side of the open channel, spaced from the first mechanical arrangement.

Advantageously, the second mechanical arrangement is provided for releasably securing the drive assembly in the operational position. Using two opposing mechanical arrangements improves the strength of the coupling between the drive assembly and the frame, reducing the risk of undesired detachment. Moreover, the drive assembly can remain robustly coupled to the frame via the first mechanical arrangement whilst being moved from the operational position to the maintenance position.

In exemplary embodiments, the first mechanical arrangement includes a first fixture point or attachment member on the frame, defining an internal bore for receiving a mounting member or fastener. Similarly, in exemplary embodiments, the second mechanical arrangement includes a second fixture point or attachment member on the frame, defining an internal bore for receiving a mounting member or fastener

Advantageously, the use of mounting member or fastener within internal bore provides a simple and easy method of coupling the drive assembly to the frame.

In exemplary embodiments, an internal bush is located in the internal bore and wherein the mounting member of fastener extends within the bore of said internal bush.

Advantageously, the use of bushes serves to mitigate vibration transfer, noise dampening and heat transfer, thereby preventing damage to the frame, thus extending the life of the frame and reducing the requirement for maintenance.

In exemplary embodiments, the first portion of the frame comprises a semi-cylindrical body.

In exemplary embodiments, the first portion of the frame defines a bottom bracket shell.

The bottom bracket shell may comprise a semi-cylindrical body.

The bottom bracket shell may be a semi-cylinder whose sides occupy the range of between 90° and 250° that of a similarly sized cylinder.

The bottom bracket shell may be a semi-cylinder whose sides occupy the range of between 130° and 180° that of a similarly sized cylinder.

The bottom bracket shell may be a semi-cylinder whose sides occupy the range of between 150° and 180° that of a similarly sized cylinder.

The bottom bracket shell may be a semi-cylinder whose sides occupy the range of between 170° and 180° that of a similarly sized cylinder.

The bottom bracket shell may include one or more attachment lugs.

The one or more attachment lugs may be provided with internal bushes.

The internal bushes may comprise a resilient material bush mounted within a metallic bush.

In exemplary embodiments, the open channel has an internal profile which is less than, greater than or equal to a semi cylinder.

Advantageously, known drive assemblies for electric bicycles are typically generally cylindrical in shape, and thus a generally semi-cylindrical open channel (i.e. semi-circular in cross-section) allows a generally cylindrical drive assembly to be easily received in and removed from the open channel. However, in some exemplary embodiments, the open channel has an internal profile which is less than semi-circular in cross section, as this allows for easier installation and removal from the open channel. Moreover, in alternative embodiments, the internal profile of the open channel may extend beyond a semi-circle in cross-section, e.g. wherein the open channel profile defines a semi-cylinder, but wherein the distal or terminal ends of the channel extend tangentially beyond the end of the semi-cylinder (e.g. so as to be generally U-shaped).

In further alternative embodiments, the open channel may have geometry which is substantially different to a semi-cylinder. For example, the internal profile of the open channel could be rectangular or another generally part-polygonal profile. Put another way, in exemplary embodiments, the first portion or bottom bracket shell of the frame defines a concavity or open chamber into which a complimentarily configured drive assembly can be received in a non-axial direction with respect to a normal operational orientation of the drive assembly.

In a second aspect of the disclosure, there is provided a frame for a pedal-drive vehicle, the frame comprising a bottom bracket shell, a seat tube, and a down tube wherein the bottom bracket shell defines an open channel in cross section, so as to be configured for receiving a bottom bracket assembly for the vehicle in a non-axial direction of the bottom bracket shell.

Optionally, the seat tube and the down tube each have an end that terminates at the bottom bracket shell.

The frame may include a top tube. The frame may include a head tube. The frame may include one or more chain stays. The frame may include one or more seat stays.

Advantageously, the open channel provides a simple and expeditious means for accessing and removing a bottom bracket assembly from a pedal-drive vehicle, thereby reducing the time associated with assembly and maintenance of the vehicle. Such an arrangement is in contrast to frames known in the art in which the bottom bracket assembly is located in a closed channel, whereby the bottom bracket assembly needs to be removed in an axial direction, and so it more difficult to remove. Indeed, removal of the bottom bracket assembly from conventional frames first requires disassembly of crank arms and other components to which the bottom bracket assembly must be coupled in use. Providing a frame which allows for non-axial removal of the bottom bracket assembly from the bottom bracket shell avoids the need for conventional disassembly of the bottom bracket assembly.

The term ‘open channel’ is intended to mean that the channel does not define a full annulus/circumference, contrary to conventional bottom bracket shells (which define a closed, fully annular profile in cross section).

In exemplary embodiments, the internal shape of the open channel is configured so that a bottom bracket assembly can be received and removed from the open channel in a non-axial direction of the bottom bracket assembly.

Advantageously, in exemplary embodiments, the internal shape of the bottom bracket shell is configured to allow a bottom bracket assembly to be received and removed from the open channel in a generally ‘radial’ direction with respect to the normal operational position of the bottom bracket assembly (that is to say, not in an ‘axial’ direction with respect to a crank axis of the bottom bracket assembly.

In exemplary embodiments, the frame includes mechanical fixture points adjacent the open channel for releasably securing a bottom bracket assembly in the open channel.

Advantageously, the use of mechanical fixture points adjacent the open channel allows a bottom bracket assembly to releasably secured in the open channel, so that the bottom bracket assembly can be easily removed from the open channel (e.g. for maintenance reasons).

In exemplary embodiments, the frame is configured so that a bottom bracket assembly is moveable out of the channel from an operational position to a maintenance position, e.g. via pivoting movement, whilst coupled to the frame by one of said fixture points (that is to say, whilst released from coupling to the other of said first and second fixture points).

Advantageously, such an arrangement provides a simple and easy means for the user to move the bottom bracket assembly between the operational and maintenance positions, allowing access to the bottom bracket assembly or the interior of the channel, without having to completely remove the bottom bracket assembly from the frame, and without having to handle the weight of the bottom bracket assembly.

In exemplary embodiments, the frame includes a first mechanical arrangement for coupling a bottom bracket assembly to the frame, and wherein the first mechanical arrangement is configured to allow the bottom bracket assembly to be moved in and out of the open channel, between an operational position and a maintenance position, whilst the bottom bracket assembly is coupled to the frame via the first mechanical arrangement.

The first mechanical arrangement advantageously allows the bottom bracket assembly to be moved in and out of the open channel whilst coupled to the frame.

In addition, the first mechanical arrangement as set forth allows for the bottom bracket assembly to remain coupled with the frame when the bottom bracket assembly is in the maintenance position i.e. removed from the channel. Such an arrangement improves the ease at which maintenance can be done to the vehicle, as the bottom bracket assembly can be easily removed from the channel without having to completely disconnect the bottom bracket assembly from the frame.

In exemplary embodiments, the first mechanical arrangement is configured for pivotably coupling the bottom bracket assembly to the frame, such that a bottom bracket assembly is able to be pivoted out of the open channel when transitioning from the operational position to the maintenance position.

Advantageously, utilising a pivotal connection is a simple means of moving the axle assembly between its operational position and maintenance position. Such an arrangement further increases the ease of accessing the open channel, and can thus expedite certain maintenance operations.

In exemplary embodiments, the frame includes a second mechanical arrangement for use in releasably securing a bottom bracket assembly in the open channel in an operational position, wherein the first mechanical arrangement is provided on one side of the open channel and the second mechanical arrangement is provided on an opposing side of the open channel, spaced from the first mechanical arrangement.

Advantageously, the second mechanical arrangement is provided for releasably securing the bottom bracket assembly in the operational position. Using two opposing mechanical arrangements improves the strength of the coupling between the bottom bracket assembly and the frame, reducing the risk of undesired detachment. Moreover, the bottom bracket assembly can remain robustly coupled to the frame via the first mechanical arrangement whilst being moved from the operational position to the maintenance position.

In exemplary embodiments, the first mechanical arrangement includes a first attachment member or fixture point on the frame, defining an internal bore for receiving a mounting member or fastener.

Advantageously, use of a mounting member or fastener within internal bore provides a simple and easy method of coupling the bottom bracket assembly to the frame.

In exemplary embodiments, an internal bush is located in the internal bore and wherein the mounting member or fastener extends within the bore of said internal bush.

Advantageously, the use of bushes serves to mitigate vibration transfer, noise dampening and heat transfer, thereby preventing damage to the frame, thus extending the life of the frame and reducing the requirement for maintenance.

In exemplary embodiments, the second mechanical arrangement includes a second attachment member defining an internal bore for receiving a mounting member or fastener.

In exemplary embodiments, an internal bush is located in the internal bore and wherein the mounting member or fastener extends within the bore of said internal bush.

In exemplary embodiments, the bottom bracket assembly is supported in the open channel by a cradle extending under the bottom bracket assembly in normal use.

In exemplary embodiments, the cradle is releasably coupled to opposing fixture points on the frame (e.g. at least one fixture point on either side of the open channel as viewed in cross section).

In exemplary embodiments, the cradle is pivotably mounted on the frame, so that the bottom bracket assembly moves out of the open channel as the cradle pivots away from the open channel.

In exemplary embodiments, the bottom bracket assembly is releasably secured to the cradle (e.g. via one or more mechanical fixtures).

In exemplary embodiments, at least one of the seat tube and the down tube has a hollow interior, and wherein the bottom bracket shell of the frame includes at least one access aperture in direct communication with said hollow interior, for access to the hollow interior via the open channel.

In the field of bicycles, it is known to locate various components (e.g. cabling) within the hollow interior of a tube in a bicycle frame. In specific field of electric bicycles, it is also known to mount a battery or motor within the hollow interior of a tube in a bicycle frame. The combination of the open channel and the access aperture affords easy access to such components, and is particularly advantageous in embodiments where a user can simply transition the bottom bracket assembly from the operational position to the maintenance position.

In exemplary embodiments, the frame further comprises at least one strengthening rib located on an internal surface or inner wall of the channel.

Advantageously, the strengthening rib serves to reduce the flexing of the frame in response to forces exhibited on the frame during use (e.g. from rotation of the pedals), thereby reducing damage to the frame and prevent the vehicle from malfunctioning. In exemplary embodiments, the bottom bracket shell comprises a semi-cylindrical body.

In exemplary embodiments, the open channel has an internal profile which is less than, greater than or equal to a semi cylinder.

Advantageously, known bottom bracket assemblies are typically generally cylindrical in shape, and thus a generally semi-cylindrical open channel (i.e. semi-circular in cross-section) allows a generally cylindrical bottom bracket assembly to be easily received in and removed from the open channel. In exemplary embodiments, the open channel has an internal profile which is less than semi-circular in cross section, as this allows for easier installation and removal from the open channel. However, in alternative embodiments, the internal profile of the open channel may extend beyond a semi-circle in cross-section, e.g. wherein the open channel profile defines a semi-cylinder, but wherein the terminal ends of the channel extend tangentially beyond the end of the semi-cylinder (e.g. so as to be generally U-shaped).

In further alternative embodiments, the open channel may have geometry which is substantially different to a semi-cylinder. For example, the internal profile of the open channel could be rectangular or another generally part-polygonal profile. Put another way, in exemplary embodiments, the bottom bracket shell defines a concavity or open chamber into which a complimentarily configured drive assembly can be received in a non-axial direction with respect to a normal operational orientation of the drive assembly.

In exemplary embodiments, the bottom bracket assembly comprises one or more lugs, each lug having eyelets arranged and configured for alignment with a respective mechanical fixture point on the frame, such that a mounting member or fastener can extend through a respective eyelet and fixture point in order to secure the bottom bracket assembly to the frame.

The frame may include a top tube. The frame may include a head tube. The frame may include one or more chain stays. The frame may include one or more seat stays.

The bottom bracket shell may comprise a semi-cylindrical body.

The bottom bracket shell may be a semi-cylinder whose sides occupy the range of between 90° and 250° that of a similarly sized cylinder.

The bottom bracket shell may be a semi-cylinder whose sides occupy the range of between 130° and 180° that of a similarly sized cylinder.

The bottom bracket shell may be a semi-cylinder whose sides occupy the range of between 150° and 180° that of a similarly sized cylinder.

The bottom bracket shell may be a semi-cylinder whose sides occupy the range of between 170° and 180° that of a similarly sized cylinder.

In exemplary embodiments, the open channel has an internal profile which is less than, greater than or equal to a semi cylinder.

Advantageously, known bottom bracket assemblies are typically generally cylindrical in shape, and thus a generally semi-cylindrical open channel (i.e. semi-circular in cross-section) allows a generally cylindrical bottom bracket assembly to be easily received in and removed from the open channel. In exemplary embodiments, the bottom bracket shell has an internal profile which is less than semi-circular in cross section, as may allow for easier installation and removal of the bottom bracket assembly. However, in alternative embodiments, the internal profile of the open channel may extend beyond a semi-circle in cross-section, e.g. wherein the open channel profile defines a semi-cylinder, but wherein the terminal ends of the channel extend tangentially beyond the end of the semi-cylinder (e.g. so as to be generally U-shaped).

In further alternative embodiments, the open channel may have geometry which is substantially different to a semi-cylinder. For example, the internal profile of the open channel could be rectangular or another generally part-polygonal profile. Put another way, in exemplary embodiments, the bottom bracket shell defines a concavity or open chamber into which a complimentarily configured drive assembly can be received in a non-axial direction with respect to a normal operational orientation of the drive assembly.

The bottom bracket shell may include one or more attachment lugs.

The one or more attachment lugs may be provided with internal bushes.

In a third aspect of the disclosure, there is provided a bush assembly, the bush assembly defining an elongate tubular body comprising a resilient material bush mounted within a metallic bush.

Advantageously, bushes serve to mitigate vibration transfer, noise dampening and heat transfer. When used in conjunction with a frame for a pedal-drive vehicle, the bush can serve to prevent damage to the frame, thus extending the life of the frame and reducing the requirement for maintenance.

According to a fourth aspect of the disclosure, there is provided a bicycle frame comprising a seat tube, a down tube and a bottom bracket shell to which the seat tube and down tube are connected, and wherein the bottom bracket shell is semi-cylindrical.

By “semi-cylindrical” it will be understood to mean that the bottom bracket shell occupies the general volume of a regular cylinder but is truncated around its sides.

The frame may include a top tube. The frame may include a head tube. The frame may include one or more chain stays. The frame may include one or more seat stays.

There may be provided apertures in the bottom bracket shell to enable access into the hollow interiors of the down tube, the seat tube and/or chain stays.

The bottom bracket shell may have an outer diameter in the range of 80 to 130 mm.

The bottom bracket shell may comprise a semi-cylindrical body.

The bottom bracket shell may be a semi-cylinder whose sides occupy the range of between 90° and 250° that of a similarly sized cylinder.

The bottom bracket shell may be a semi-cylinder whose sides occupy the range of between 130° and 180° that of a similarly sized cylinder.

The bottom bracket shell may be a semi-cylinder whose sides occupy the range of between 150° and 180° that of a similarly sized cylinder.

The bottom bracket shell may be a semi-cylinder whose sides occupy the range of between 170° and 180° that of a similarly sized cylinder.

The bottom bracket shell may include one or more attachment lugs.

The one or more attachment lugs may be provided with internal bushes.

The internal bushes may be metallic.

The internal bushes may be a resilient material.

The resilient material may be rubber.

The internal bushes may comprise a resilient material bush mounted within a metallic bush.

According to a fifth aspect of the disclosure, there is provided a bicycle including at least one frame according to the second aspect or fourth aspect.

The bicycle may be electric.

The bicycle may include at least one drive unit or drive assembly.

The drive unit or drive assembly may include an electric motor.

The drive unit or drive assembly may include a gearing system.

The drive unit or drive assembly may include a pedal crank system.

The drive unit or drive assembly may include a motor control unit.

The drive unit or drive assembly may include one or more mounting lugs.

The drive unit or drive assembly may include four mounting lugs.

The mounting lugs may comprise a pair of threaded and smooth bore lugs.

Bolts may attach through the mounting lugs and attachment lugs of the bottom bracket shell.

According to a sixth aspect of the disclosure, there is provided a method of manufacturing a bicycle frame comprising the steps of joining a seat tube, a down tube and a bottom bracket shell wherein the bottom bracket shell is semi-cylindrical, or defines a concavity or open chamber into which a complimentarily configured drive unit can be received in a non-axial direction with respect to a normal operational orientation of the drive unit.

### BRIEF DESCRIPTION OF THE DRAWINGS

FIG. 1 is a side elevation of a pedal-driven vehicle according to the present teachings;

FIG. 2 is a side elevation of a frame for a pedal-driven vehicle according to an embodiment of the present teachings;

FIG. 3 is a side elevation of a view of a first portion or a bottom bracket of the frame according to the embodiment of FIG. 2;

FIG. 4 is a perspective view from below the first portion of the frame of FIG. 2;

FIG. 5 is a further perspective view from below the first portion of the frame of FIG. 2;

FIG. 6 is a perspective view from below the frame of FIG. 2 with a drive assembly located in a maintenance position;

FIG. 7 is a perspective view of the frame of FIG. 2 with a drive assembly or bottom bracket assembly located in an operational position;

FIG. 8 is a perspective view of the frame of FIG. 2 with a drive assembly located in a maintenance position;

FIG. 9 is a perspective view of the first portion of the frame of FIG. 2 with a drive assembly located in an operational position;

FIG. 10 is a perspective view of the first portion of the frame of FIG. 2 with a drive assembly located in a maintenance position;

FIG. 11 is a perspective view of metal and rubber bushings;

FIG. 12 is a perspective view of the drive assembly and first portion of the frame of the vehicle of FIG. 1;

FIG. 13 is a perspective view of a frame for a pedal-driven vehicle according to an embodiment of the present teachings, having a drive assembly located in a maintenance position;

FIG. 14 is a side elevation view of a first portion of the frame of FIG. 13;

FIG. 15 is a perspective view of a frame for a pedal-driven vehicle according to an embodiment of the present teachings, having a drive assembly located in a maintenance position;

FIG. 16 is a side elevation view of a first portion of the frame of FIG. 15;

FIG. 17 is a perspective view of a frame for a pedal-driven vehicle according to an embodiment of the present teachings, having a drive assembly located in a maintenance position;

FIG. 18 is a side elevation view of a first portion of the frame of FIG. 17; and

FIG. 19 is a schematic of a drive assembly according to an embodiment of the present teachings.

### DETAILED DESCRIPTION OF EMBODIMENTS

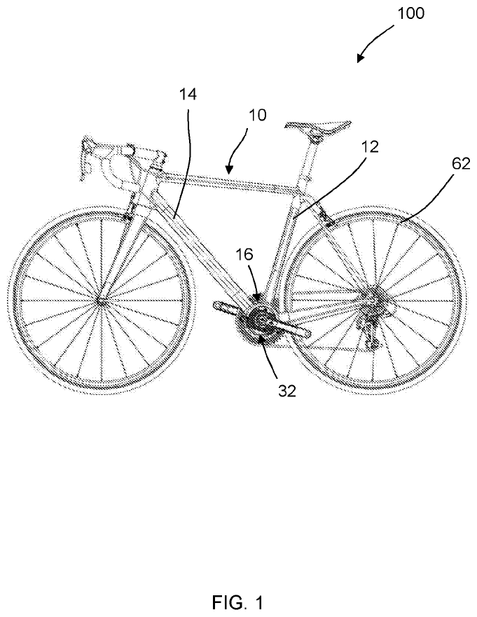

Referring to FIG. 1, a pedal-drive vehicle is indicated generally at 100 in the form of a bicycle, more particularly an electric bicycle having a motor for providing motive force.

The vehicle 100 includes a frame 10. In this embodiment, the frame 10 has a seat tube 12, a down tube 14 and a first portion 16 in which is mounted a drive assembly 32 having a pedal crank axle. The first portion may be considered as a ‘bottom bracket shell’ of the frame, and the drive assembly might otherwise be referred to as a bottom bracket assembly.

In this embodiment, the seat tube 12 and down tube 14 are directly connected to the first portion. Specifically, the seat tube 12 and the down tube 14 each have an end that terminates at the first portion 16. It may be advantageous to connect the seat tube 12 and down tube 14 to the first portion 16 via welding. Other joining methods are possible. The seat tube 12 and down tube 14 are typically hollow.

The frame is formed from a suitable bicycle grade aluminium, but may be formed from other suitable materials, such as other metals and alloys, carbon fibre, etc.

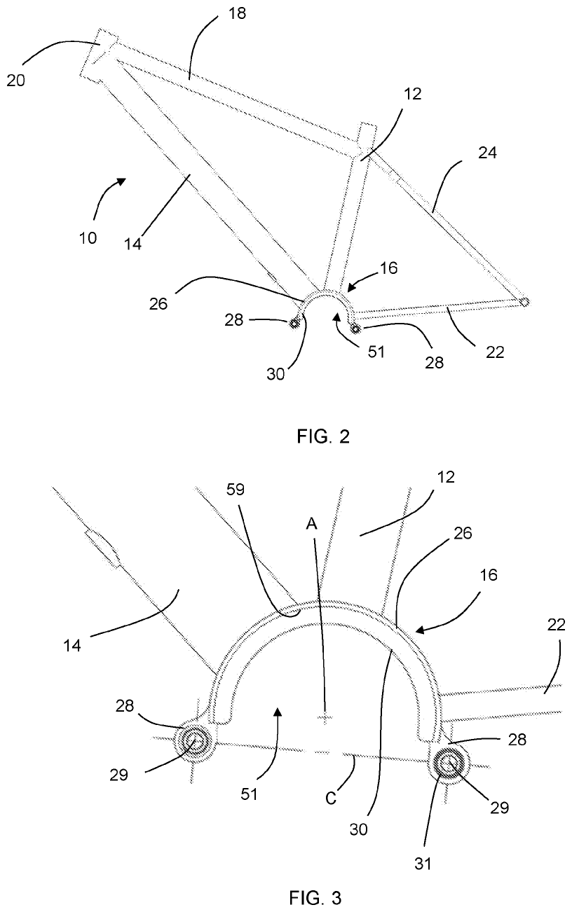

FIGS. 2 and 3 show the frame 10 of FIG. 1, which includes a top tube 18, a head tube 20, two chain stays 22 and two seat stays 24. The chain stays 22 and seat stays 24 are of a type known in the art and are connected at distal ends thereof with a known arrangement of lugs and so forth to provide a mounting point for a rear axle, wheel, derailleur gear etc.

Importantly, the first portion 16 of the frame 10 defines an open channel 51. The term ‘open channel’ is intended to mean that the channel 51 does not define a full annulus/circumference, and so is contrary to bottom bracket shells in conventional bicycle frames (which define a closed, fully annular profile in cross section).

Known drive assemblies or bottom bracket assemblies for electric bicycles are typically generally cylindrical in shape, and thus a generally semi-cylindrical open channel 51 (i.e. an open channel which is generally semi-circular in cross-section) will be advantageous for allowing a generally cylindrical drive assembly to be easily received in and removed from the open channel 51, for example in a non-axial direction of the open channel. Such an arrangement is in contrast with bottom bracket shells of the prior art, which tend to be fully cylindrical and allow for installation of the drive assembly in only an axial direction of the bottom bracket shell.

A frame with an open channel of the kind set forth is also easier to manufacture, and allows for easier access to the drive assembly (e.g. for maintenance purposes). Moreover, the open channel 51 enables airflow across the bottom of the drive assembly in use. The airflow allows cooling of a drive assembly. Moreover, ducting may be applied to the lower surface of a drive assembly to encourage airflow around said drive assembly, further enhancing the air-cooling effect.

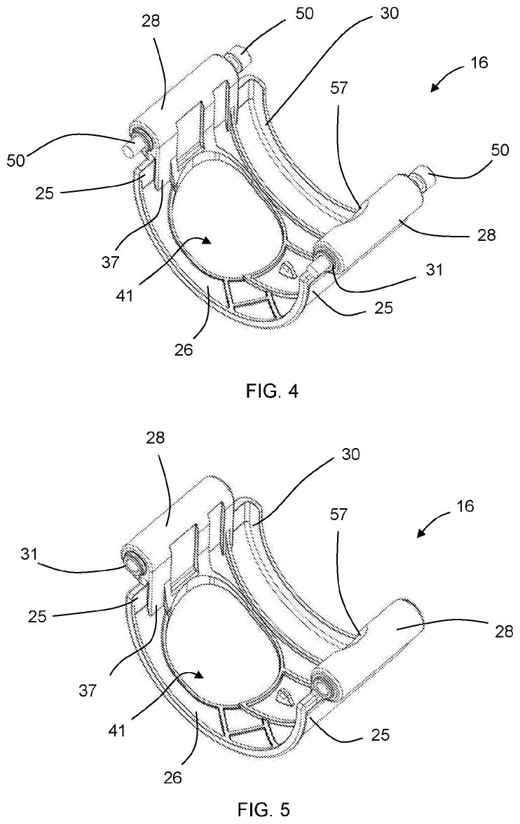

As can be seen best in FIGS. 4 and 5, the first portion has a body 26 and planar lips 25 extend parallel to one another at respective terminal edges of the body 26. So, although an internal curvature of the open channel 51 in cross section defines a semi-cylinder, the terminal ends of the channel 51 extend in a tangential direction beyond semi-cylindrical (such that the channel can be said to be of a truncated U-shape profile in cross-section).

In the illustrated embodiment of FIGS. 1 to 5, a strengthening rib 30 is provided at one end of the open channel 51. The strengthening rib serves to reduce the flexing of the frame in response to forces exhibited on the frame during use (e.g. from rotation of pedals), thereby reducing damage to the frame and preventing the vehicle from malfunctioning.

In exemplary embodiments, the strengthening rib 30 is located adjacent the non-drive side end of the first portion 16, as will be described in more detail below. The strengthening rib 30 has a lip or flange structure extending away from the internal surface of the open channel 51. Locating the rib 30 as set forth can serve to protect the interior of the first portion 16 of the frame 10 from dirt and debris that may accumulate during use of the vehicle 100, thereby preventing damage to any of the components of the drive assembly.

Referring to FIGS. 4, 5 and 6, the frame 10 includes at least one access aperture 41, arranged to provide communication with either the seat tube 12, down tube 14, or both. In exemplary embodiments, the access aperture 41 is provided in the first portion 16 of the frame 10 so as to provide direct communication to a hollow interior of the corresponding tube 12, 14 (for access to the hollow interior, via the open channel 51).

The frame 10 further includes mechanical fixture points or attachment members 28 provided adjacent the open channel 51. The mechanical fixture points 28 are used for releasably securing a drive assembly 32 in the open channel 51, and to allow the drive assembly 32 to be easily removed from the open channel 51.

In exemplary embodiments, first and second fixture points 28 are provided, one on either side of the open channel 51 as viewed in cross section. In the illustrated embodiments, two mechanical fixture points 28 are provided, each located adjacent a respective distal or terminal end of the open channel 51 as viewed in cross section.

In the embodiment of FIGS. 1 to 6, the mechanical fixture points 28 are attached adjacent the terminal ends of the planar lips 25.

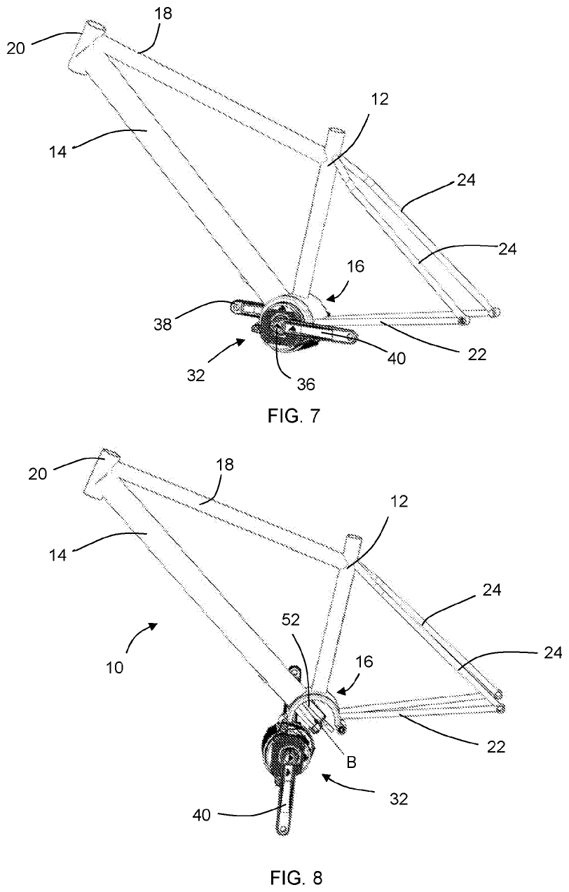

Movement of the drive assembly relative to the frame will now be described with respect to FIGS. 7 to 10. Firstly, however, more details of the drive assembly 32 will be described.

As can be seen, the drive assembly 32 has a generally cylindrical shape complementary to the interior of the first portion 16. That is to say, the drive assembly 32 defines a generally cylindrical body 34.

A pedal crank axle 36 is located within the body 34, and projects from either end of the drive assembly 32. A drive side crank 38 and non-drive side crank 40 are releasably attached at respective ends of the pedal crank axle 36.

The drive assembly 32 defines a longitudinal operational axis A when located within the open channel 51.

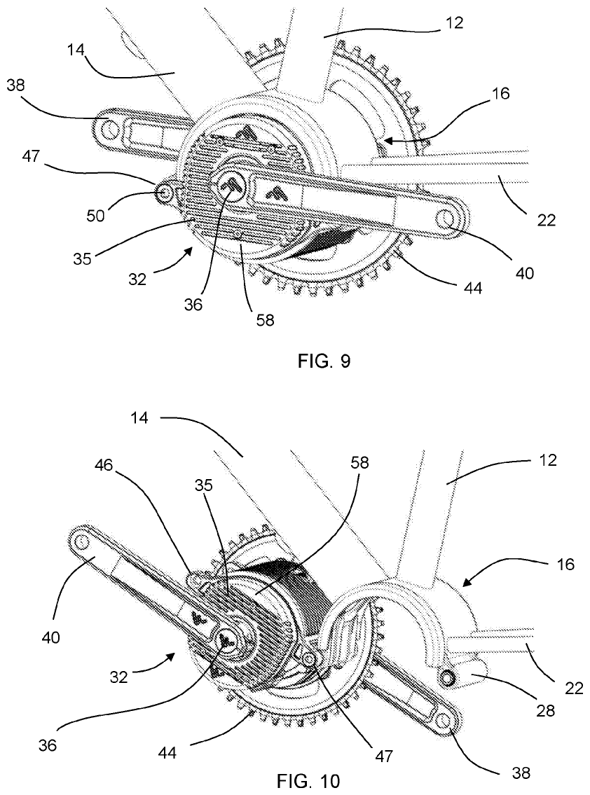

As can be seen most clearly in FIGS. 9 and 10, a protective cover 58 is located over each axial end face of the body 34. The cover 58 may serve to act as a protective barrier or ‘shield’ so as to prevent dirt or debris from entering into the channel 51 during operation of the vehicle, thereby preventing damage to any of the internal components of the vehicle.

In alternative or additional embodiments (not illustrated), the drive assembly 32 may define a first diameter at a first region of the drive assembly 32 and a second diameter at a second region of the drive assembly 32. The second diameter is greater than the first diameter, such that the first region locates within the channel 51, and the second region extends beyond the first portion 16 of the frame 10 in the radial direction. Such an arrangement is particularly advantageous when the second region is located on the non-drive side of the drive assembly 32, i.e. not adjacent the chain ring 44, since this prevents damage to internal components.

In some embodiments, one or more drive assembly rubber bushings (not shown) may be fitted around the drive assembly 32 and therefore between the body 34 and the internal surface of the bottom bracket shell 16. These bushings mitigate vibration transfer, noise dampening, heat transfer etc.

In the illustrated embodiment, cooling fins 35 are provided on the body 34, for example around the intended lower surface of the body 34 and across the cover 58 at either axial end of the body 34.

The vehicle 100 is an electric bicycle, and so the drive assembly 32 is electrical. The vehicle 100 includes a battery 52 for providing power to the drive assembly 32. In exemplary embodiments, the battery 52 is located within a compartment or a hollow interior of one of the seat tube 12 and down tube 14. Various other components may locate also within the hollow interior of the tubes, for example cables, controllers, other control means (not shown) etc.

In exemplary embodiments, the battery 52 has an elongate body configured to extend along a length of the seat tube 12 or down tube 14.

It should be appreciated that the battery may be fixed within the seat tube 12 or down tube 14, and maintained in power-providing communication with the drive assembly 32 by any suitable means.

In exemplary embodiments, the battery 52 is stabilised at an upper end of the seat tube 12 or down tube 14. The battery 52 may be stabilised by a gasket, for example a rubber gasket, or another similar damping material.

In some embodiments, the battery 52 is releasably fixed at a lower end of the seat tube 12 or down tube 14, for example with an M10 fixing.

In the illustrated embodiments, the battery 52 provides power via the access aperture 41 in the first portion 16, such that the battery 52 can communicate with the drive assembly 32 through the aperture 41.

In the illustrated embodiments, the battery 52 is provided in the down tube 14, and the access aperture 41 is located to provide direct communication with the hollow interior of the down tube 14. It shall be appreciated that the battery 52 may be located elsewhere, or there may be multiple batteries provided in one or more tubes. Multiple access apertures may be provided to provide communication with the hollow interior of other tubes.

In exemplary embodiments, the or each battery is connected to the drive assembly 32 via at least one cable.

As mentioned previously, and as can be seen clearly in FIG. 8 and FIG. 10, the drive assembly 32 can be released from the open channel 51.

The frame 10 is configured such that the battery 52 is removable along an axis of reciprocation B within the seat tube 12 or down tube 14, via the aperture 41 in the first portion 16 when the drive assembly 32 is released from the open channel 51.

The battery 52 can be removed from the frame 10 through the open channel 51 when the drive assembly 32 has been released from an operational position (i.e. from the position of FIGS. 7 and 9 to the position of FIGS. 8 and 10). Such an arrangement is in contrast to the prior art, where the battery 52 is often difficult to access and requires an access point through a wall in a tube of the frame 10.

The combination of the open channel 51 and the access aperture 41 affords easy access to any components within the tubes 12, 14.

In exemplary embodiments, e.g. of the kind shown in FIG. 8, the axis of reciprocation B of the battery 52 intersects the intended operational axis A of the drive assembly 32.

In exemplary embodiments, the battery 52 has an elongate body with a length greater than a maximum width of the open channel 51 as viewed in cross section.

In exemplary embodiments, the frame 10 is configured such that the battery 52 is removable from the open channel 51 without coming into contact the frame 10.

Such an arrangement facilitates the easy removal of a full-sized battery 52 from the interior of one of the tubes without any risk of damaging the battery 52 or the frame 10 via impact between the battery 52 and the frame 10.

The drive assembly 32 includes at least one lug 46, 47 for cooperation with a respective mechanical fixture point 28 on the frame 10. The illustrated embodiment includes four lugs, but it should be appreciated that any suitable number of lugs could be used to secure the drive assembly 32 to the frame 10.

The lugs 46, 47 are provided on the exterior of the drive assembly 32. Two drive side lugs 46 are provided on the drive side axial end of the drive assembly 32. Two non-drive side lugs 47 are provided on the non-drive side axial end of the drive assembly 32. The drive assembly lugs 46, 47 are provided on either side of the drive assembly 32 and at either axial end thereof in a position intended to correspond to that of a respective fixture point 28 on the frame 10.

In exemplary embodiments, the drive assembly lugs 46, 47 are located at around four and eight o'clock positions, approximately 110° and 250° from a point top dead centre of the drive assembly 32, giving the first portion 16 an effective circumference of around 220°.

The frame 10 is configured such that the drive assembly 32 is moveable or can swing out of the channel from an operational, or fitted, position (e.g. see FIG. 7 and FIG. 9) to a maintenance, or access, position (e.g. see FIG. 8 and FIG. 10), e.g. via a pivoting movement, when coupled to one of said fixture points 28 and released from the other. The operational position is the arrangement of the drive assembly 32 when the vehicle 100 is ready for, or in, use. The maintenance position is the arrangement when the drive assembly 32 has been removed from the open channel 51, such that the internal side of the first portion 16 of the frame can be accessed (e.g. for removal of the battery).

To that extent, it can be said that the frame 10 includes a first mechanical arrangement for coupling the drive assembly 32 to the frame 10. The first mechanical arrangement is configured to allow the drive assembly 32 to be moved in and out of the open channel 51, between the operational and the maintenance positions. The drive assembly 32 can move between the two positions whilst the drive assembly 32 is coupled to the frame 10 via the first mechanical arrangement, e.g. via a pivoting movement.

Advantageously, the first mechanical arrangement allows for the drive assembly 32 to remain coupled with the frame 10 when the drive assembly 32 is in the maintenance position i.e. removed from the channel 51. Such an arrangement improves the ease at which maintenance can be done to the vehicle 100 or the frame 10, as the drive assembly 32 can be easily removed from the channel 51 without having to completely disconnect the drive assembly 32 from the frame 10.

Utilising a pivotal connection between the frame 10 and drive assembly 32 provides a simple means of moving the drive assembly 32 between its operational position and maintenance positions. Such an arrangement further increases the ease of accessing the open channel 51 and can thus expedite certain maintenance operations.

In exemplary embodiments, the frame 10 includes a second mechanical arrangement for releasably securing the drive assembly 32 in the open channel 51 in an operational position, whilst the drive assembly is coupled with the first mechanical arrangement. In such embodiments, the first mechanical arrangement is provided on one side of the open channel 51, and the second mechanical arrangement is provided on an opposing side of the open channel 51, spaced from the first mechanical arrangement.

In exemplary embodiments, the first and second mechanical arrangements are provided adjacent a respective distal or terminal end of the open channel 51 as viewed in cross section.

Using two opposing mechanical arrangements improves the strength of the coupling between the drive assembly 32 and the frame 10, reducing the risk of undesired detachment. Moreover, the drive assembly 32 can remain robustly coupled to the frame 10 via the first mechanical arrangement whilst being moved from the operational position to the maintenance position.

It will be understood that, in the illustrated embodiments, the first and second mechanical arrangements are provided by respective attachment members or fixture points 28 on the frame. The fixture points define an internal bore 29, for receiving a mounting member or fastener 50. The bores 29 are provided parallel to the operational axis A of the drive assembly 32.

The use of a mounting member or fastener 50 within the internal bore 29 of an attachment member 28 provides a simple and easy method of coupling the drive assembly 32 to the frame 10.

In exemplary embodiments of the kind illustrated, each lug 46, 47 on the drive assembly 32 has an eyelet 48, 49. Each eyelet is arranged and configured for alignment with a respective fixture point 28 on the frame 10. A mounting member or fastener 50 can extend through a respective eyelet 48, 49 and fixture point 28 so as to secure the drive assembly 32 to the frame 10, allowing for pivotable movement about a longitudinal axis of a respective bore 29.

Although the figures indicate four lugs on the drive assembly 32, it should be appreciated that any suitable number of lugs could be used to secure the drive assembly 32 to the frame 10.

In exemplary embodiments, each mounting member or fastener is a bolt 50. However, it should be appreciated that any suitable fastener can be used.

The bolts 50 are used to fasten the lugs 46, 47 to the attachment members 28 on the first portion 16 of the frame 10. Use of a bolt 50 provides a simple means of detaching the drive assembly 32 from the frame 10 so as to move the assembly 32 into the maintenance position, and a simple means of reattaching the unit to the frame to return to the operational position.

In exemplary embodiments, it may be advantageous for the eyelets 49 on the non-drive side lugs 47 to have a smooth bore, and for the eyelets 48 on the drive side lugs 46 to have a threaded bore.

The bolts 50 can be fed first through the smooth bore aperture 49 on the non-drive side drive assembly lugs 47, through the centre of the rubber and steel bushings 31, 33 within the attachment members 28 and then engage the threading of the threaded aperture 48 on the drive side drive assembly lugs 46. Such an arrangement mounts the drive assembly 32 into the first portion 16.

In exemplary embodiments, e.g. as shown in FIGS. 4 and 5, an internal bush is located in the internal bore 29 of the first and/or second attachment member 28. The use of bushes serves to mitigate vibration transfer, noise dampening and heat transfer, thereby preventing damage to the frame 10, thus extending the life of the frame 10 and reducing the requirement for maintenance.

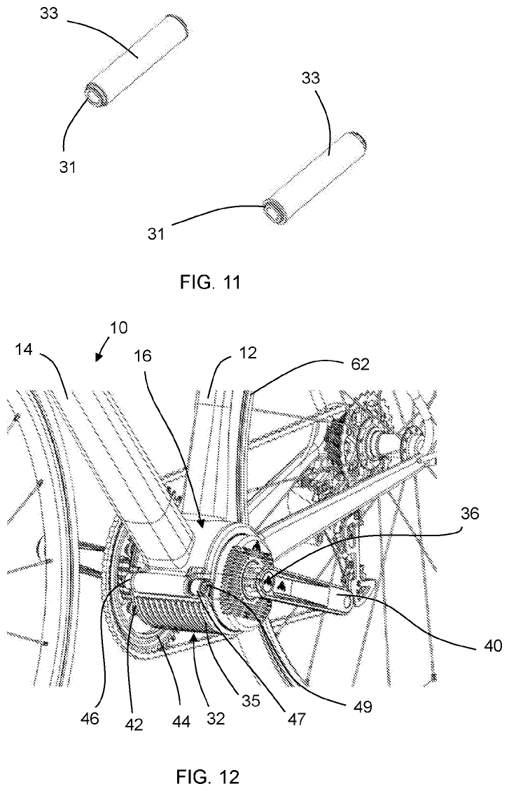

An exemplary embodiment of two internal bushes can be seen in FIG. 11. The bushes are for receiving in a bore and have an elongate tubular body. The bushes may be metallic, a resilient material, or any other suitable material. In the illustrated embodiment, each bush has a resilient material bush 31 mounted within a metallic bush 33.

As illustrated most clearly in FIGS. 4 and 5, four bushes are provided within each bore 29 for a total of eight bushes. Two rubber bushes 31 and two steel bushes 33 are provided with the rubber bushes 31 being located within the steel bushes 33. The bushes in the figures are flanged or top hat type.

In alternative embodiments, two bushes may be provided within each bore 29 for a total of four bushes (not illustrated). One rubber bush 31 and one steel bush 33 are provided with the rubber bushes 31 being located within the steel bushes 33. It should be appreciated that any suitable arrangement of bushes and material may be used.

It will be understood that alternative bushes may be employed and need not be flanged or top hat type. For example, metalastic bushes may be employed (not illustrated). There may only be one metalastic bush per bore required.

The manner in which the drive assembly 32 may be mounted within or removed from the first portion 16 allows for simple assembly, disassembly and servicing of the drive assembly 32 and/or other components of the bicycle. Moreover, the battery 52 can be removed from the frame 10 (e.g. for recharging or replacing) without having to completely disconnect the drive assembly 32 from the frame 10.

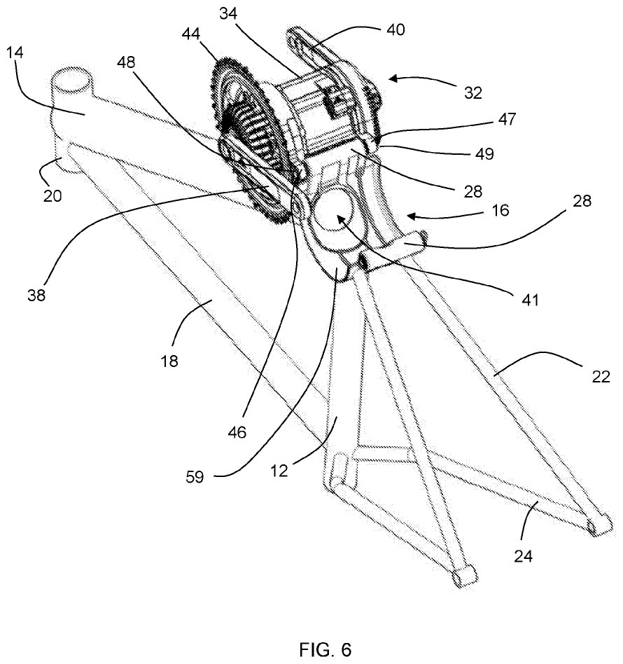

FIGS. 6, 8 and 10 show the drive assembly 32 pivoted to the maintenance position. In the illustrated example, the bolt 50 adjacent the chain stays 22 has been removed so as to allow the drive assembly 32 to pivot around the remaining bolt 50 located adjacent the down tube 14.

It should be appreciated that the frame 10 may be configured such that the drive assembly 32 can pivot around either bolt 50.

The bushes 31, 33, attachment member 28, lugs 46, 47 and bolts 50 enable the pivoting. However, it should be appreciated that the drive assembly may be pivotably connected to the frame 10 via alternative means.

The pivoting of the drive assembly enables servicing, fitting, and/or replacement of components that may be placed into either or both tubes 12, 14, such as a battery 52, drive unit control means, cabling (not shown), etc.

The attachment members 28, lugs 46, 47 and bolts 50 combine to form hinge mechanisms, allowing the drive assembly 32 to be pivoted between an operational position and a maintenance position. However, it should be appreciated that the hinge mechanism may be provided via alternative means.

It may be advantageous to provide lug mounting ribs 37 within the first portion 16, e.g. as can be seen in FIGS. 4 to 5. The lug mounting ribs 37 project along a portion of the inner wall or internal surface of the channel 51 to the attachment member 28. It should be appreciated that any number of lug mounting ribs 37 may be provided. In use, the lug mounting ribs 37 form part of the inside of the attachment members 28 and provide reinforced mounting points along the length of the members 28.

The lug mounting ribs 37 project along the interior sidewall of the first portion 16. Some of the lug mounting ribs 37 may be partially truncated around the aperture 41. The mounting ribs 37 provide a localised thickening of the first portion 16 to provide reinforcement, which is particularly important when the drive assembly 32 is in the maintenance position and the weight of the assembly 32 is localised about one of the attachment members 28. Furthermore, the ribs 37 can serve as a guide to assist in locating the drive unit 32 in the optimal position during fitting to the frame 10.

It may also be advantageous to configure at least one attachment member 28 so as to compliment an outer surface of the drive assembly 32. The configuration prevents the attachment member 28 from impeding the drive assembly 32 during transition between the operational and maintenance positions.

As can be most clearly seen in FIGS. 4 and 5, an edge 57 of one of the attachment members 28 has a curved recess. In alternative embodiments, both attachment members 28 may have a curved recess, or the entire member 28 may be configured so as to compliment the shape of the drive assembly

Such a configuration may serve to prevent damage to the drive assembly 32 during transition between the operational and maintenance positions. The arrangement may also improve the ease of transitioning the drive assembly 32, and thus the simplicity of accessing the channel inner wall/internal surface and/or the drive assembly 32 itself. Furthermore, the configured edge 57 may also serve to improve the ease of extracting the battery 52 without damage, or without requiring the battery 52 to bend.

Referring now to FIG. 12, it can be seen that the vehicle 100 includes a chain spider 42 and chain ring 44 mounted adjacent the drive side crank 38, in use, and the non-drive side crank 40 is located distally from the chain spider 42. The electric motor and pedal crank axle 36 both impart motion on the chain spider 42 and chain ring 44. When connected to a chain and to a back wheel of a fully assembled bicycle, the motive force of both rotational inputs (i.e. the pedal crank and the motor) may impart motion on the rear wheel 62.

It will be understood that embodiments of this disclosure are described in relation to a vehicle frame having an open chamber or concavity for receiving a drive assembly having a crank axle. A range of cross-sectional profiles for the open channel or concavity have been discussed.

It is important to recognise that the internal surface of the open channel will typically be selected to be complimentary to the external shape of the drive assembly which is intended to be located in the open channel.

Conventional drive assemblies for electric bicycles are typically cylindrical in shape, thus having a curved outer surface. For such drive assembles, the open channel will have an internal surface with an arc of curvature which is complimentary to the curved outer surface of the drive assembly, e.g. so that the drive assembly can nest within the open channel, or be otherwise supported therein, to resist against unwanted movement or rattling within the open channel.

However, if the drive assembly is not cylindrical, e.g. if the drive assembly is of polygonal or part-polygonal external profile (e.g. square or rectangular) when viewed in axial cross section, the internal surface of the open channel may be of a complimentary internal profile.

It will be appreciated that the external profile of the drive assembly may not be of uniform contour, e.g. the external profile of the drive assembly may define one of more projections and/or recesses (such as ribs or grooves etc). Accordingly, the open channel may be configured with a complimentary internal contour. By way of example, the drive assembly 32 in FIG. 6 includes include numerous external formations on the generally cylindrical outer surface.

Whatever the external shape of the drive assembly, for exemplary embodiments of the invention, the internal profile of the open channel is shaped so as to facilitate unobstructed movement of the drive assembly into and out of the open channel in a non-axial direction of the channel (e.g. by a pivoting movement).

Put another way, for all exemplary embodiments, the first portion or bottom bracket shell of the frame may define a concavity or open chamber into which a complimentarily configured drive assembly can be received in a non-axial direction with respect to a normal operational orientation of the drive assembly.

It should also be appreciated that the internal surface of the first portion 16 may not be uniform. By way of example, FIG. 6 shows numerous inside formations on the internal surface of the first portion 16, such as a strengthening rib 30 on the internal surface, and lug mounting ribs 37 that project along the internal surface.

So, the external surface of the drive assembly 32 may be arranged so as to compliment formations on the internal surface of the first portion 16 (e.g. shaped complimentarily to the strengthening rib 30 and the lug mounting ribs 37), and both or either of the drive assembly 32 and the first portion 16 may be configured so as to not cause obstruction to the drive assembly 32 as it moves into its operational position within the open channel 51 or during removal of the drive assembly 32 from the open channel 51, i.e. in a movement which is non axial with respect to the longitudinal axis of the open channel 51.

As has been illustrated, only a portion of the drive assembly 32 is received in the open channel 51. The first portion 16 has an internal surface 59 that is shaped to be complimentary to an outer surface of the portion of the drive assembly 32 that is intended to be received in the open channel 51. More specifically, the internal surface 59 is shaped so as to facilitate unobstructed movement of said portion of the drive assembly 32 into and out of the open channel 51 in a non-axial direction.

In some examples (e.g. in examples where the drive assembly 32 is a non-uniform shape), the internal surface 59 may only be complimentary to the portion of the drive assembly 32 intended to be received in the open channel 51. In such an example, a specific portion of the drive assembly 32 is intended to be received in the open channel 51, and the internal surface 59 is configured to be complimentary to the specific portion.

In exemplary embodiments, the internal surface 59 of the first portion 16 defines a first and a second end at distal ends of the open channel 51 when viewed in cross section. The first portion 16 is configured such that a width between the ends of the internal surface 59 is less than a maximum width of the portion of the drive assembly 32 that is intended to be received in the open channel 51, so as to facilitate unobstructed movement of the drive assembly 32 into and out of the open channel 51.

As described above, the embodiment of FIGS. 1 to 12 has a bottom bracket shell 16 with an internal surface 59 which is greater than a semicylinder in cross section, since it has an internal profile which defines a semicylindrical portion with tangential extensions (i.e. to define a truncated U-shape). In this embodiment, the mechanical fixture points 28 as viewed in cross section are aligned along an axis of alignment C. The frame 10 is configured such that the axis of alignment C is offset from the operational axis A of the drive assembly 32 in a downward direction, i.e. in the direction of the open end of the open channel 51.

Alternative methods of coupling the drive assembly 32 to the frame 10 may be utilised. For example, it may be desirable to releasably secure the drive assembly to a cradle (not shown) e.g. via one or more mechanical fixtures.

In such an embodiment, the drive assembly 32 is supported in the open channel 51 by a cradle extending under the drive assembly 32 in normal use. The cradle is releasably coupled to opposing fixture points on the frame (e.g. at least one fixture point on either side of the concavity as viewed in cross section). The cradle is pivotably mounted on the frame 10, so that the drive assembly 32 moves out of the open channel 51 as the cradle pivots away from the open channel.

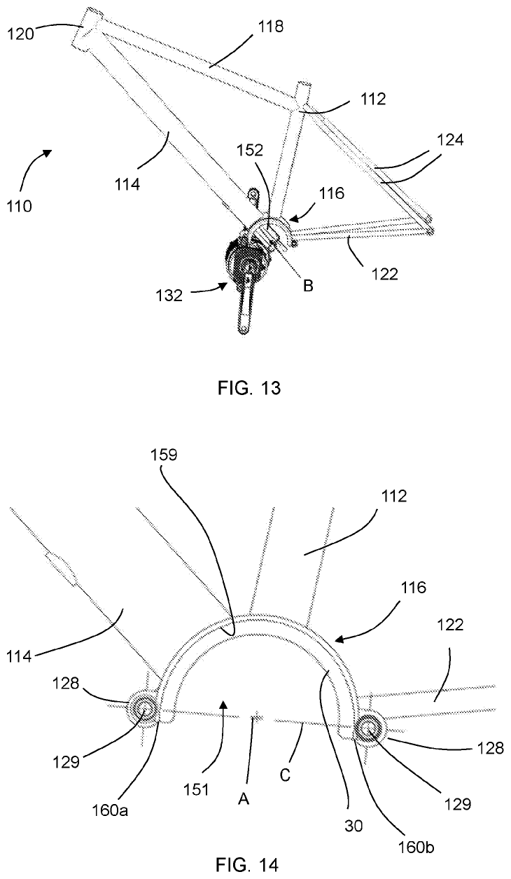

FIGS. 13 and 14 show another frame for a pedal-drive vehicle according to another embodiment. Only the differences between the present embodiment and the previously described embodiment will be described here, and similar reference numerals are used but with a suffix “1”.

The internal profile of the first portion 116 is of generally semicylindrical cross section. In particular, as can be seen clearly in FIG. 14, the first portion 116 has an internal surface 159 that is semi-circular in axial cross-section. The internal surface 159 has a first end 160a and a second end 60b. In FIG. 14, the first and second ends 160a, 160b are endpoints of a diameter of a semi-circle.

As can be seen, frame 110 is configured such that the axis of alignment C of the mechanical fixture points 128 viewed in cross section is in alignment with the operational axis A of the drive assembly 132 (i.e. not offset therefrom).

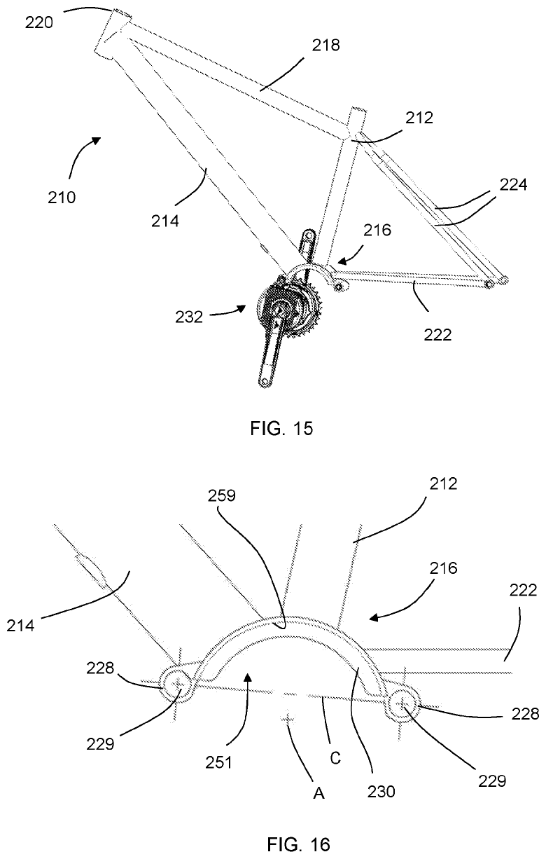

FIGS. 15 and 16 show another frame for a pedal-drive vehicle according to another embodiment. Only the differences between the present embodiment and the previously described embodiment will be described here, and similar reference numerals are used but with a suffix “2”.

The first portion 216 has an internal profile which is less than semi-circular in cross section. If the open channel has an internal profile which is less than semi-circular in cross section, this may allow for easier installation and removal of a drive assembly from the open channel, for example.

As can be seen most clearly in FIG. 16, the first portion has a curved internal surface 259 that defines an arc when viewed in axial cross-section. The arc is a minor arc (i.e. less than a semi-circle).

In exemplary embodiments in which the internal profile of the bottom bracket shell/open channel has only a single arc of curvature, the arc of curvature may extend in a range of 180° to 130° with respect to a central axis. In some embodiments, the arc of curvature extends in a range of 180° to 150° with respect to a central axis. In some embodiments, the arc of curvature extends in a range of 180° to 170°, with respect to a central axis. Alternatively (as in FIG. 14), the arc of curvature extends approximately 180° with respect to a central axis.

In example embodiments, the first portion 16 may have a body 26 that is semi-cylindrical. The body 26 is generally in the form of a semi-cylinder whose sides occupy the range of between 90° and 220° around a central axis of that of a similarly sized full cylinder. More specifically, in some embodiments, the angle is 180° or around 50% of the circumference of the sidewall of such a cylinder. In some embodiments, the semi-cylindrical body 26 has a diameter in the general range of 80 mm to 120 mm, and specifically an outer diameter 123 mm in the present embodiment.

As can be seen, frame 210 is configured such that the axis of alignment C of the mechanical fixture points 228 viewed in cross section is offset from the operational axis A of the drive assembly 232 in an upward direction, i.e. in the direction away from the open end of the open channel 251.

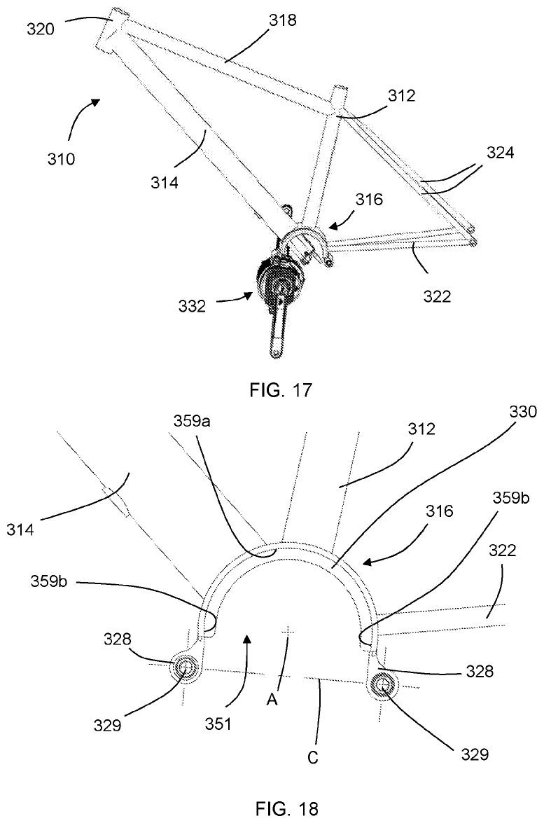

FIGS. 17 and 18 show another frame for a pedal-drive vehicle according to another embodiment. Only the differences between the present embodiment and the previously described embodiment will be described here, and similar reference numerals are used but with a suffix “3”.

The first portion 316 has an internal profile that is generally greater than semi-circular in cross section (e.g. substantially U-shaped). Specifically, the first portion 316 has an internal surface 359 with a first segment 359a and a second segment 359b. The first segment 359a defines an arc when viewed in axial cross-section. The arc is a minor arc. The arc has an arc of curvature that is complimentary to the outer surface of the drive assembly intended to be received in the open channel 351.

The second segment 359b defines an extension/projection that extends laterally from one or both ends of the first segment 359a. The second segment 359b does not define a curve but is straight. The first segment 359a defines an arc of a full virtual circle. The second segment 359b does not intersect the virtual circle defined by the first segment 359a. Such an arrangement permits a drive assembly 332 with a curved outer surface to locate complimentarily within the first segment 359a, with the second segment 359b extending at the end/ends of the first segment 359a adjacent to the installed drive assembly 332.

The arrangement of FIG. 18 may provide additional support to the drive assembly 332, without obstructing movement of the drive assembly 332 into and out of the open channel 351 in a non-axial direction.

As can be seen, frame 310 is configured such that the axis of alignment C of the mechanical fixture points 328 viewed in cross section is offset from the operational axis A of the drive assembly 332 in a downward direction, i.e. in the direction of the open end of the open channel 351.

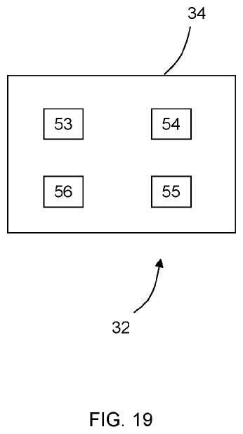

FIG. 19 is provided as a schematic diagram for an exemplary embodiment of a drive assembly 32 for mounting on the frame 10. As can be seen, the drive assembly includes a pedal crank system 56. The pedal crank system 56 includes a crank axle 36 in exemplary embodiments. The drive assembly 32 includes an electric motor 53. The drive assembly 32 includes a gearing system 54. The drive assembly 32 includes a motor control unit 55. The drive assembly may include all of the above components housed within a body 34.

It will be understood, for exemplary embodiments in which the vehicle 100 is an electric bicycle or the like, the pedal crank system 56 is an assembly configured to allow pedal drive input as well as motor drive input. The pedal crank system includes the pedal crank 38, 40 and a crank axle 36. In some embodiments, the pedal crank axle 36 is arranged to receive auxiliary drive input from the motor 53.

In alternative embodiments, the motor 53 may not locate within the body 34. For example, the motor 53 may locate within the down tube 14, seat tube 16 or elsewhere on the vehicle 100 and arranged for operative communication of drive to a rear wheel 62 of the bicycle. In some embodiments, the motor 53 may be positioned above the battery 52 in the seat tube 12 or down tube 14.

It will be understood that in exemplary embodiments the vehicle includes a battery 52 for supplying power to the drive assembly 32 (e.g. to the motor 53). The battery 52 can be coupled to the drive assembly 32 via one or more cables or electrical contacts.

One-way bearings may be used within the drive assembly to insulate the two rotational motion sources from one another. Such arrangements are known within the field of electric bicycles, e.g. in patent applications GB1203211.6, GB1515082.4 and GB1716311.4. Therefore, such arrangements will not be discussed in further detail.

Embodiments of this disclosure has been described in relation to an open channel of a bottom bracket shell of a bicycle in which a seat tube and/or down tube terminate at the bottom bracket shell, such that a battery may be stored within the seat tube or down tube, and be removed through and aperture in the bottom bracket where the seat tube and/or down tube terminate at the bottom bracket shell. However, it will be understood that this disclosure is also applicable to embodiments in which the frame is of a more complex or less conventional form (i.e. having a seat tube and/or down tube which does not terminate directly at the bottom bracket shell). To that extent, the disclosure is specifically intended to cover a frame for a pedal driven vehicle, wherein the frame includes a first portion that defines an open channel, and wherein the frame includes fixture points for releasably securing a drive assembly having a crank axle to the frame, such that the drive assembly can be secured in the open channel, via the fixture points, so as to define an operational crank axis of the drive assembly. The frame may define one or more compartments for receiving a battery, so that the battery can be arranged in communication with the drive assembly for the transfer of motive power from the battery to the drive assembly (i.e. for driving the crank axle) whilst the battery is located in the compartment. The frame may be configured so that the battery is removable from the compartment via the open channel, e.g. via one or more apertures in the frame in communication between the open channel and the compartment. As with other embodiments described herein, the drive assembly may be moveable in and out of the open channel in a movement which is in a non-axial direction of the channel. The drive assembly may be moved (e.g. pivoted) from an operational position within the open channel to a maintenance position within the open channel, when coupled to one of the fixture points. Such movement may be in a non-axial direction of the channel. It will be understood that other features of the illustrated embodiments of this disclosure are optionally applicable.

The disclosure may also cover a method of manufacturing a pedal driven vehicle having a frame according to any of the described embodiments. For example, the disclosure provides a method of manufacturing a frame for pedal drive vehicle, wherein the method involves producing a frame having a first portion that defines an open channel, and fixture points for releasably securing a drive assembly having a crank axle in the open channel. The method may include producing a frame having one or more compartments for receiving a battery, e.g. so that the battery can be arranged in communication with the drive assembly secured in the open channel for the transfer of motive power from the battery to the drive assembly (i.e. for driving the crank axle) whilst the battery is located in the compartment. The method may include producing a frame configured so that the battery is removable from the compartment via the open channel, e.g. via one or more apertures in the frame in communication between the open channel and the compartment. The method may include producing a frame configured so that a drive assembly having a crank axle may be moveable in and out of the open channel in a movement which is in a non-axial direction of the channel. The method may include producing a frame configured so that a drive assembly having a crank axle may be moved (e.g. pivoted) from an operational position within the open channel to a maintenance position within the open channel, when coupled to one of the fixture points, e.g. in a movement which is in a non-axial direction of the channel.

Although all the embodiments have been described with reference to a bicycle, e.g. a pedal driven vehicle having two wheels, it should be appreciated that this disclosure is applicable to other forms of pedal driven vehicles having a crank axle, e.g. tricycles or the like.

1. A pedal-drive vehicle comprising a frame having a first portion, a seat tube, and a down tube, wherein the seat tube and the down tube each have an end that terminates at the first portion;
wherein the first portion of the frame defines an open channel;
wherein a drive assembly having a crank axle and an electric motor is releasably securable in the open channel, such that the drive assembly defines a longitudinal operational axis;
wherein a battery is located within a compartment or hollow interior of one of the seat tube and the down tube;
wherein the battery is provided for transmission of auxiliary power to the electric motor of the drive assembly, via an aperture in the first portion, such that the battery can communicate with the drive assembly through the aperture when in the compartment or hollow interior;
wherein the frame is configured such that the battery is removable from the compartment or hollow interior along an axis of reciprocation within the seat tube or down tube, via the aperture in the first portion, when the drive assembly is released from the open channel;
wherein the frame includes mechanical fixture points adjacent the open channel for releasably securing the drive assembly in the open channel; and
wherein the vehicle is configured so that the drive assembly is moveable out of the channel when coupled to one of said fixture points, wherein the drive assembly is configured to be pivotably connected to the frame such that the drive assembly is moveable out of the channel via a pivoting movement.

2. A vehicle according to claim 1, wherein the open channel is configured for receiving the drive assembly in a non-axial direction of the channel and/or drive assembly.

3. A vehicle according to claim 1, wherein first and second fixture points are provided on opposing sides of the open channel to one another as viewed in cross section.

4. A vehicle according to claim 3, wherein the drive assembly comprises one or more lugs, each lug having an eyelet arranged and configured for alignment with a respective mechanical fixture point on the frame, such that a mounting member or fastener can extend through a respective eyelet and fixture point, in order to secure the drive assembly to the frame.

5. A vehicle according to claim 1, wherein the vehicle includes a first mechanical arrangement for coupling the drive assembly to the frame, and wherein the first mechanical arrangement is configured to allow the drive assembly to be moved in and out of the open channel, between an operational position and a maintenance position, whilst the drive assembly is coupled to the frame via the first mechanical arrangement.

6. A vehicle according to claim 5, wherein the first mechanical arrangement is configured for pivotably coupling the drive assembly to the frame, such that the drive assembly is able to pivot out of the open channel when transitioning from the operational position to the maintenance position.

7. A vehicle according to claim 5, wherein the vehicle includes a second mechanical arrangement for use in releasably securing the drive assembly in the open channel in an operational position, wherein the first mechanical arrangement is provided on one side of the open channel and the second mechanical arrangement is provided on an opposing side of the open channel, spaced from the first mechanical arrangement.

8. A vehicle according to claim 7, wherein the first mechanical arrangement includes a first attachment member defining an internal bore for receiving a mounting member or fastener.

9. (canceled)

10. A vehicle according to claim 1, wherein the first portion comprises an internal surface configured to compliment an outer surface of the drive assembly.

11. A vehicle according to claim 1, wherein the first portion comprises a curved internal surface, such that the open channel has a curved internal profile defining an axial cross-section having an arc of curvature that extends approximately 180°, with respect to a central axis.

12. (canceled)

13. (canceled)

14. (canceled)

15. (canceled)

16. (canceled)

17. (canceled)

18. (canceled)

19. (canceled)

20. A method of installing a drive assembly for a pedal driven vehicle, the method comprising the steps of:
providing a drive assembly having a crank axle;
providing a frame for a pedal driven vehicle, wherein the frame includes a first portion that defines an open channel and wherein the frame includes fixture points for releasably securing the drive assembly to the frame;
wherein the method comprises the further step of securing the drive assembly in the open channel via the fixture points such that the drive assembly is pivotably connected to the frame, and wherein the drive assembly is moveable in and out of the open channel via a pivoting movement in a non-axial direction of the channel, when coupled to one of said fixture points.

21. A vehicle according to claim 3, wherein the first and second fixture points are provided adjacent a respective distal end of the open channel as viewed in cross section.

22. A vehicle according to claim 21, wherein the vehicle is configured so that the drive assembly can swing out of the channel from an operational position to a maintenance position, via pivoting movement, when coupled to one of said fixture points.

23. A vehicle according to claim 8, wherein an internal bush is located in the internal bore and wherein the mounting member of fastener extends within the bore of said internal bush.

24. A vehicle according to claim 23, wherein the bush is metallic and/or is a resilient material and/or comprises a resilient material bush mounted within a metallic bush.

25. A vehicle according to claim 10, wherein the internal surface includes projections and the outer surface of the drive assembly includes recesses into which the projections are received when the drive assembly is releasably secured in the open channel.

26. A vehicle according to claim 11, wherein the open channel has a curved internal profile defining an axial cross-section having an arc of curvature that extends in a range of 180° to 130°, with respect to the central axis.

27. A vehicle according to claim 11, wherein the open channel has a curved internal profile defining an axial cross-section having an arc of curvature that extends in a range of 180° to 150°, with respect to the central axis.

28. A vehicle according to claim 11, wherein the open channel has a curved internal profile defining an axial cross-section having an arc of curvature that extends in a range of 180° to 170°, with respect to the central axis.
